(19) United States
(12) Patent Application Publication
(10) Pub. No.: US 2007/0139401 A1
(43) Pub. Date: Jun. 21, 2007

(54) Display with an interactive lighting frame

(75) Inventors: Beniz Wang, Taipei (TW); Hsiang Chen, Taipei (TW); Tien-Ming Chan, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/313,576

(22) Filed: Dec. 20, 2005

(51) Int. Cl. G09G 5/00

(52) U.S. Cl. 345/204

(57) ABSTRACT

A display having a lighting frame includes a display portion, a frame and at least a lighting element. The display portion provides contents for viewing. The frame, made of a transparent material, surrounds the display portion and includes a space for containing the lighting element. The lighting element is electrically connected to a driving signal so as to illuminate according to the driving signal.

### BACKGROUND OF THE INVENTION

1. Field of Invention

The invention generally relates to a display, and in particular relates to a display having an interactive lighting frame.

2. Description of the Related Art

Nowadays, technologies are being developed so fast that kinds of electronic products are blooming into markets. Computers may be the most important and useful electronic products for modern people. Whatever a desktop computer or a notebook computer being used, a display is required for showing the input and output information. Therefore, monitors or displays are important components that arouse the attentions of users and makers.

Display makers are trying to develop new products that can attract customers. How to improve the function and performance of a display from original structure but with less additional or total cost so as to improve its competitive strength and market share is the aim of manufacturers.

### SUMMARY OF THE INVENTION

The main objective of the invention is to provide a display having a lighting frame that can illuminate itself.

The secondary objective of the invention is to provide a display having an interactive lighting frame that can illuminate according to a driving signal.

In order to achieve the objectives, a display having a lighting frame according to the invention includes a display portion, a frame and at least a lighting element. The display portion provides contents for viewing. The frame surrounds the display portion and includes a space for containing the lighting element. The lighting element is electrically connected to a driving signal so as to illuminate according to the driving signal.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a perspective view of a display with a lighting frame according to the invention;

FIG. 2 is a sectional view of the invention taken from section A-A of FIG. 1;

FIG. 3 is an alternative sectional view of the invention taken from section A-A of FIG. 1; and

FIG. 4 is a block diagram showing the composition and function of an embodiment of the invention.

### DETAILED DESCRIPTION OF THE PREFERRED EMBODIMENT

The characteristics of the invention are to apply a transparent frame for containing the lighting elements set on rear side of a display; a signal sensing and driving element is also included for driving the lighting elements according to the received signal.

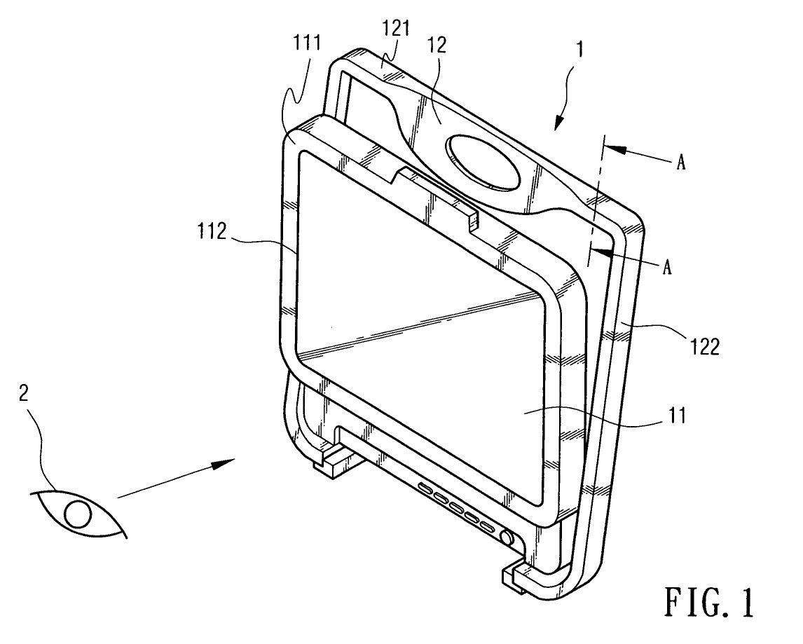

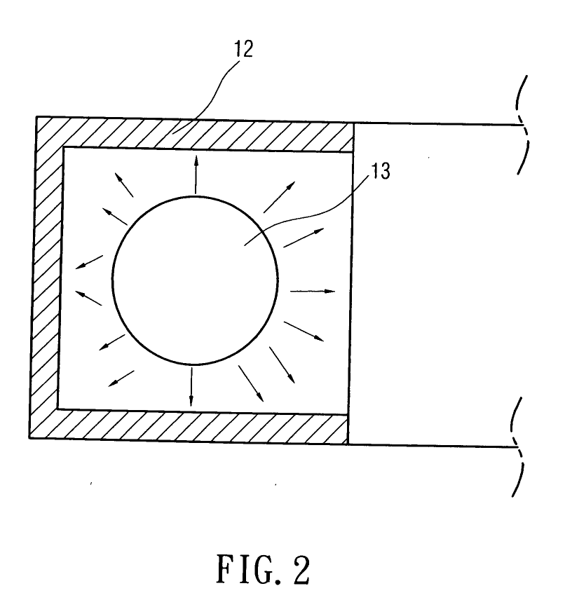

Referring to FIGS. 1 and 2, a display 1 having an interactive lighting frame according to the invention includes a display portion 11, a frame 12 and at least a lighting element 13. The display portion 11 provides contents for users 2 to view. In the embodiment, the display portion 11 has two horizontal sides 111 and two vertical sides 112. A frame 12 surrounds and extrudes from the back of the display portion 11. At least a lighting element 13 is mounted inside the frame 12. The frame 12 is composed of two horizontal sides 121 and two vertical sides 122 and having space for containing the lighting element 13. The lighting element 13 is placed in any or all of the horizontal sides 121 and vertical sides 122.

As shown in FIG. 2, a sectional view of the invention taken from section A-A of FIG. 1, the lighting element 13 can be a single or multiple light source(s) mounted inside any side or multiple sides of the frame 12. The number and positions of the lighting elements 13 can be modified in the manners of prior arts.

The frame 12 is made of transparent material, such as acrylic or polyvinyl chloride (PVC), and an integrated structure for containing the lighting element 13. The lighting element 13 is electrically connected to a driving signal (not shown in the FIG.) so as to illuminate according to the driving signal.

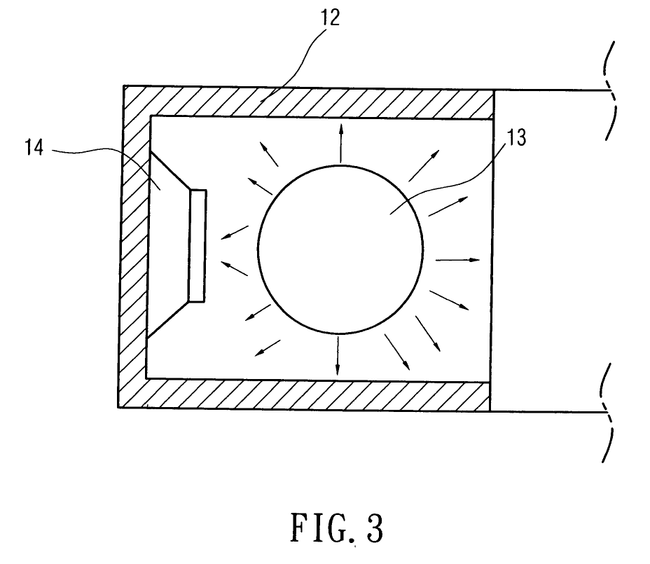

FIG. 3 is an alternative sectional view of the invention taken from section A-A of FIG. 1. Differing from the embodiment of FIG. 2, the frame 12 in FIG. 3 further contains a sound element 14 for providing sounds coordinating with the display portion 11 and/or the lighting element 13. For example, when the display portion 11 displays an animation, the lighting element 13 gives light variation, and the sound element 14 provides the corresponding sound.

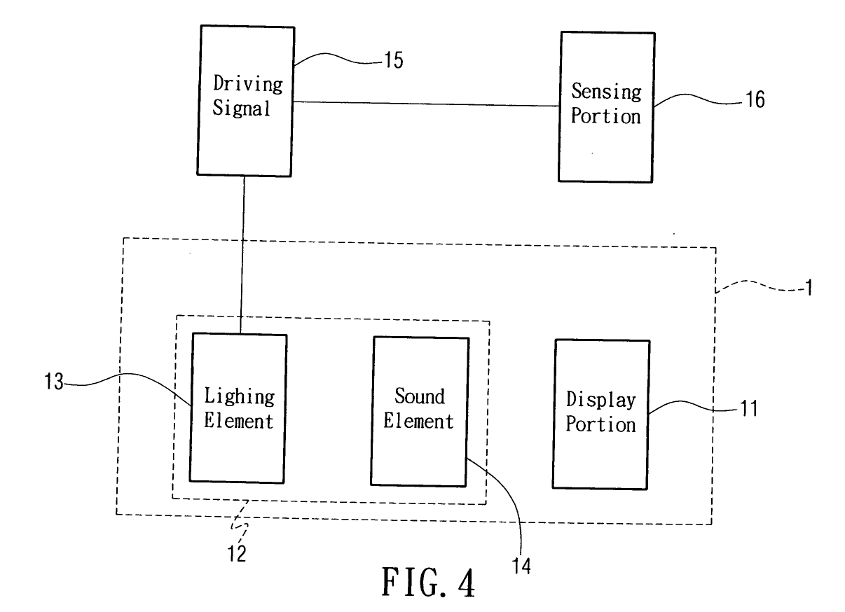

FIG. 4 shows a block diagram of an embodiment of the invention. The display 1 is connected to a driving signal 15. The driving signal 15 is also electrically connected to a sensing portion 16. The driving signal 15 is electrically connected with the lighting element 13 for activating the lighting element 13. The sensing portion 16 receives signals from an unshown peripherals or a computer (not shown in the FIG.), for example, a sound input, a radio signal or an email received signal, then controls the driving signal 15 to activate the lighting element 13. The lighting element 13 provides lighting effects, such as different color or gradual variation of light, according to the driving signal 15. Of course the sensing portion 16 can be omitted so that the lighting element 13 is simply driven by the driving signal 15 for illumination or display (such as the time) purpose. Therefore, a display according to the invention includes an interactive lighting frame. As for the choice and control function of light element, they are of prior arts and will not be detailed described herein.

In an embodiment of the invention, light emitting diodes (LED) are used as lighting elements. Of course, other light sources, such as cold cathode fluorescent lamp (CCFL) can also be used.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A display having a lighting frame, comprising:
a display portion, for providing contents for viewing;
a frame, connected with and surrounding said display portion; made of a transparent material and formed with a space; and
a lighting element, contained in said space of frame and electrically connected to a driving signal for illuminating according to said driving signal.

2. The display having a lighting frame according to claim 1 further comprising a sound element contained in said space.

3. The display having a lighting frame according to claim 1 further comprising a sensing portion for controlling said driving signal according to a received signal.

4. The display having a lighting frame according to claim 3 wherein said received signal is a sound.

5. The display having a lighting frame according to claim 3 wherein said received signal is corresponding to an email received of a computer.

6. The display having a lighting frame according to claim 1 wherein said lighting element comprises a plurality of light emitting diodes.

7. A display having a lighting frame according to claim 6 wherein said light emitting diodes provide different color lights.

8. The display having a lighting frame according to claim 1 wherein said transparent material for said frame is acrylic.

9. The display having a lighting frame according to claim 1 wherein said transparent material for said frame is polyvinyl chloride (PVC).

10. The display having a lighting frame according to claim 1 wherein said frame surrounds and extrudes from back of said display portion.

11. The display having a lighting frame according to claim 1 wherein said lighting element shows the time.
